(19) United States
(12) Patent Application Publication
(10) Pub. No.: US 2009/0243468 A1
(43) Pub. Date: Oct. 1, 2009

(54) ARYLIMINO-ISOINDOLINE COMPLEXES FOR USE IN ORGANIC LIGHT EMITTING DIODES

(76) Inventors: Mark E. Thompson, Anaheim, CA (US); Kenneth Hanson, Los Angeles, CA (US); Peter Djurovich, Long Beach, CA (US); Laurent Griffe, Los Angeles, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/059,949

(22) Filed: Mar. 31, 2008

Related U.S. Application Data
(60) Provisional application No. 60/999,109, filed on Oct. 16, 2007.

(51) Int. Cl. H01J 1/63; C07F 5/00; C07F 17/02

(52) U.S. Cl. 313/504; 534/15; 544/225; 546/10; 548/402; 548/108

(57) ABSTRACT

Materials comprising emissive arylimino-isoindoline complexes comprising 1,3-bis(2-pyridylimino)isoindoline (BPI) transition metal and lanthanide complexes as described. Organic light emitting devices comprising these complexes are also described.

### CROSS-REFERENCES TO RELATED APPLICATIONS

This application claims priority to U.S. Provisional Application Ser. No. 60/999,109, filed Oct. 16, 2007, the disclosure of which is herein expressly incorporated by reference in its entirety.

This invention was made with Government support under Contract No. W15P7T-06-C-T201 awarded by Army Office of Research under the Small Business Innovative Research Program. The government has certain rights in this invention.

The claimed invention was made by, on behalf of, and/or in connection with one or more of the following parties to a joint university corporation research agreement: Regents of the University of Michigan, Princeton University, The University of Southern California, and the Universal Display Corporation. The agreement was in effect on and before the date the claimed invention was made, and the claimed invention was made as a result of activities undertaken within the scope of the agreement.

### FIELD OF THE INVENTION

The present invention relates to organic light emitting devices (OLEDs), and organic complexes used in these devices.

### BACKGROUND

Opto-electronic devices that make use of organic materials are becoming increasingly desirable for a number of reasons. Many of the materials used to make such devices are relatively inexpensive, so organic opto-electronic devices have the potential for cost advantages over inorganic devices. In addition, the inherent properties of organic materials, such as their flexibility, may make them well suited for particular applications such as fabrication on a flexible substrate. Examples of organic opto-electronic devices include organic light emitting devices (OLEDs), organic phototransistors, organic photovoltaic cells, and organic photodetectors. For OLEDs, the organic materials may have performance advantages over conventional materials. For example, the wavelength at which an organic emissive layer emits light may generally be readily tuned with appropriate dopants.

OLEDs make use of thin organic films that emit light when voltage is applied across the device. OLEDs are becoming an increasingly interesting technology for use in applications such as flat panel displays, illumination, and backlighting. Several OLED materials and configurations are described in U.S. Pat. Nos. 5,844,363, 6,303,238, and 5,707,745, which are incorporated herein by reference in their entirety.

One application for phosphorescent emissive molecules is a full color display. Industry standards for such a display call for pixels adapted to emit particular colors, referred to as “saturated” colors. In particular, these standards call for saturated red, green, and blue pixels. Color may be measured using CIE coordinates, which are well known to the art.

As used herein, the term “organic” includes polymeric materials as well as small molecule organic materials that may be used to fabricate organic opto-electronic devices. “Small molecule” refers to any organic material that is not a polymer, and “small molecules” may actually be quite large. Small molecules may include repeat units in some circumstances. For example, using a long chain alkyl group as a substituent does not remove a molecule from the “small molecule” class. Small molecules may also be incorporated into polymers, for example as a pendent group on a polymer backbone or as a part of the backbone. Small molecules may also serve as the core moiety of a dendrimer, which consists of a series of chemical shells built on the core moiety. The core moiety of a dendrimer may be a fluorescent or phosphorescent small molecule emitter. A dendrimer may be a “small molecule,” and it is believed that all dendrimers currently used in the field of OLEDs are small molecules.

As used herein, “top” means furthest away from the substrate, while “bottom” means closest to the substrate. Where a first layer is described as “disposed over” a second layer, the first layer is disposed further away from substrate. There may be other layers between the first and second layer, unless it is specified that the first layer is “in contact with” the second layer. For example, a cathode may be described as “disposed over” an anode, even though there are various organic layers in between.

As used herein, “solution processible” means capable of being dissolved, dispersed, or transported in and/or deposited from a liquid medium, either in solution or suspension form.

A ligand is referred to as “photoactive” when it is believed that the ligand contributes to the photoactive properties of an emissive material.

More details on OLEDs, and the definitions described above, can be found in U.S. Pat. No. 7,279,704, which is incorporated herein by reference in its entirety.

The development of improved blue emissive phosphorescent dopants remains an underdeveloped area in OLED research. While phosphorescent OLED devices with emission peaks in the deep blue or near-UV have been demonstrated, these devices often have poor properties that must be improved for most commercial applications. The development of novel blue emissive dopant materials, such as the (BPI)PtCl group of emitters, may play a major role in the highly sought after improvements in OLED properties.

### SUMMARY OF THE INVENTION

Materials for use in an OLED are provided. The materials are arylimino-isoindoline complexes. The materials have an emissive complex having the formula:

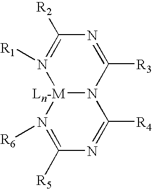

where M is a transition metal or a lanthanide. n is 0, 1, 2, 3, 4, 5, or 6, and there are n independently selected ligands L. L is a monodentate, bidentate, or tridentate ligand. Each of R₁, R₂, R₃, R₄, R₅, and R₆ is independently selected from the group consisting of hydrogen, alkyl, aryl, and heteroaryl. One or more of R₁, R₂, R₃, R₄, R₅, and R₆ may be linked. At least one of the pairs R₁ and R₂, R₃ and R₄, and R₅ and R₆ is linked to form a cyclic group.

In an aspect, the materials have a complex where each of the pairs R₁ and R₂, R₃ and R₄, and R₅ and R₆ are linked to form a cyclic group.

In an aspect, the materials have a complex where at least 1 additional aryl or heteroaryl is fused to the pair R₁ and R₂, R₃ and R₄, and R₅ and R₆ that is linked to form a cyclic group.

In an aspect, the pair R₃ and R₄ is linked to form a cyclic group and is a hydrocarbon or a heteroatomic group.

In an aspect, the pair R₁ and R₂ is linked to form a cyclic group and is a heteroatomic group.

In an aspect, each of the pairs R₁ and R₂, and R₅ and R₆ are linked to form a cyclic group and are a heteroatomic group.

In an aspect, the materials have a complex where M is Pt.

In an aspect, the materials have a complex having the formula:

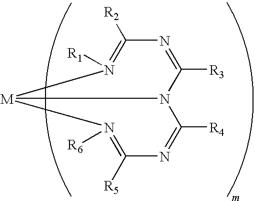

where m is 1, 2, or 3.

In an aspect, the pair R₃ and R₄ is linked to form a cyclic group to which multiple metals are coordinated. Each of the metals may have its own R₁ and R₂, and R₅ and R₆ pairs, in addition to being coordinated to the complex with the pair R₃ and R₄.

An organic light emitting device is also provided. The device has an anode, a cathode, and an organic layer disposed between the anode and the cathode. The organic layer further comprises a material containing a complex having the formula described in the preceding paragraphs. In an aspect, the device comprises a material containing a complex where each of the pairs R₁ and R₂, R₃ and R₄, and R₅ and R₆ are linked to form a cyclic compound. Preferably the organic layer is an emissive layer having a host and a dopant, and the complex is the emissive dopant.

### BRIEF DESCRIPTION OF THE DRAWINGS

FIG. 1 shows an organic light emitting device.

FIG. 2 shows an inverted organic light emitting device that does not have a separate electron transport layer.

FIG. 3 shows general ligand synthesis.

FIG. 4 shows ligands with abbreviated labels.

FIG. 5 shows absorption spectra of ligands BPI, BPBI, and BPPP.

FIG. 6 shows absorption spectra of ligands BIBI, BIPP, and BII.

FIG. 7 shows general platinum complex synthesis.

FIG. 8 shows platinum complexes with abbreviated labels.

FIG. 9 shows absorption spectra of platinum complexes (BPI)PtCl, (BPBI)PtCl, and (BPPP)PtCl.

FIG. 10 shows emission spectra of platinum complexes (BPBI)PtCl, (BPI)PtCl and (BPPP)PtCl.

FIG. 11 shows absorption of platinum complexes (BII)PtCl and (BIPP)PtCl.

FIG. 12 shows emission spectra of platinum complex (BII)PtCl.

FIG. 13 shows an emissive complex.

FIG. 14 shows the proton NMR spectrum of diphenylfumaronitrile.

FIG. 15 shows the proton NMR spectrum of the ligand BPPP.

FIG. 16 shows the proton NMR spectrum of the ligand BPI.

FIG. 17 shows the proton NMR spectrum of the ligand BPBI.

FIG. 18 shows the proton NMR spectrum of the ligand BIPP.

FIG. 19 shows the proton NMR spectrum of the ligand BII.

FIG. 20 shows the proton NMR spectrum of the ligand BIBI.

FIG. 21 shows the proton NMR spectrum of the platinum complex (BPPP)PtCl.

FIG. 22 shows the proton NMR spectrum of the platinum complex (BPI)PtCl.

FIG. 23 shows the proton NMR spectrum of the platinum complex (BPBI)PtCl.

FIG. 24 shows the proton NMR spectrum of the platinum complex(BIPP)PtCl.

### DETAILED DESCRIPTION

Generally, an OLED comprises at least one organic layer disposed between and electrically connected to an anode and a cathode. When a current is applied, the anode injects holes and the cathode injects electrons into the organic layer(s). The injected holes and electrons each migrate toward the oppositely charged electrode. When an electron and hole localize on the same molecule, an “exciton,” which is a localized electron-hole pair having an excited energy state, is formed. Light is emitted when the exciton relaxes via a photoemissive mechanism. In some cases, the exciton may be localized on an excimer or an exciplex. Non-radiative mechanisms, such as thermal relaxation, may also occur, but are generally considered undesirable.

The initial OLEDs used emissive molecules that emitted light from their singlet states (“fluorescence”) as disclosed, for example, in U.S. Pat. No. 4,769,292, which is incorporated by reference in its entirety. Fluorescent emission generally occurs in a time frame of less than 10 nanoseconds.

More recently, OLEDs having emissive materials that emit light from triplet states (“phosphorescence”) have been demonstrated. Baldo et al., “Highly Efficient Phosphorescent Emission from Organic Electroluminescent Devices,” Nature, vol. 395, 151-154, 1998; (“Baldo-I”) and Baldo et al., “Very high-efficiency green organic light-emitting devices based on electrophosphorescence,” Appl. Phys. Lett., vol. 75, No. 3, 4-6 (1999) (“Baldo-II”), which are incorporated by reference in their entireties. Phosphorescence is described in more detail in U.S. Pat. No. 7,279,704 at cols. 5-6, which are incorporated by reference.

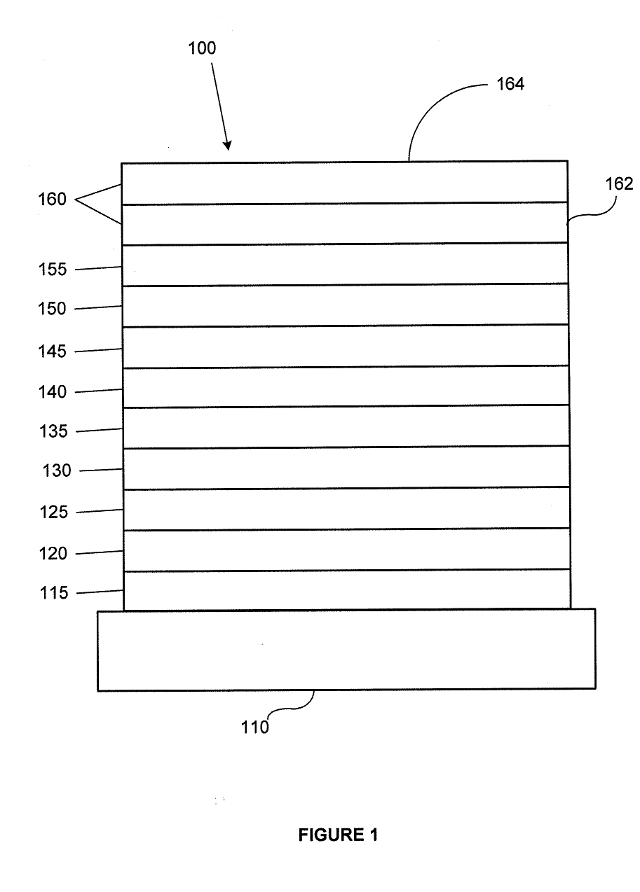

FIG. 1 shows an organic light emitting device 100. The figures are not necessarily drawn to scale. Device 100 may include a substrate 110, an anode 115, a hole injection layer 120, a hole transport layer 125, an electron blocking layer 130, an emissive layer 135, a hole blocking layer 140, an electron transport layer 145, an electron injection layer 150, a protective layer 155, and a cathode 160. Cathode 160 is a compound cathode having a first conductive layer 162 and a second conductive layer 164. Device 100 may be fabricated by depositing the layers described, in order. The properties and functions of these various layers, as well as example materials, are described in more detail in U.S. Pat. No. 7,279,704 at cols. 6-10, which are incorporated by reference.

More examples for each of these layers are available. For example, a flexible and transparent substrate-anode combination is disclosed in U.S. Pat. No. 5,844,363, which is incorporated by reference in its entirety. An example of a p-doped hole transport layer is m-MTDATA doped with F.sub.4-TCNQ at a molar ratio of 50:1, as disclosed in U.S. Patent Application Publication No. 2003/0230980, which is incorporated by reference in its entirety. Examples of emissive and host materials are disclosed in U.S. Pat. No. 6,303,238 to Thompson et al., which is incorporated by reference in its entirety. An example of an n-doped electron transport layer is BPhen doped with Li at a molar ratio of 1:1, as disclosed in U.S. Patent Application Publication No. 2003/0230980, which is incorporated by reference in its entirety. U.S. Pat. Nos. 5,703,436 and 5,707,745, which are incorporated by reference in their entireties, disclose examples of cathodes including compound cathodes having a thin layer of metal such as Mg:Ag with an overlying transparent, electrically-conductive, sputter-deposited ITO layer. The theory and use of blocking layers is described in more detail in U.S. Pat. No. 6,097,147 and U.S. Patent Application Publication No. 2003/0230980, which are incorporated by reference in their entireties. Examples of injection layers are provided in U.S. Patent Application Publication No. 2004/0174116, which is incorporated by reference in its entirety. A description of protective layers may be found in U.S. Patent Application Publication No. 2004/0174116, which is incorporated by reference in its entirety.

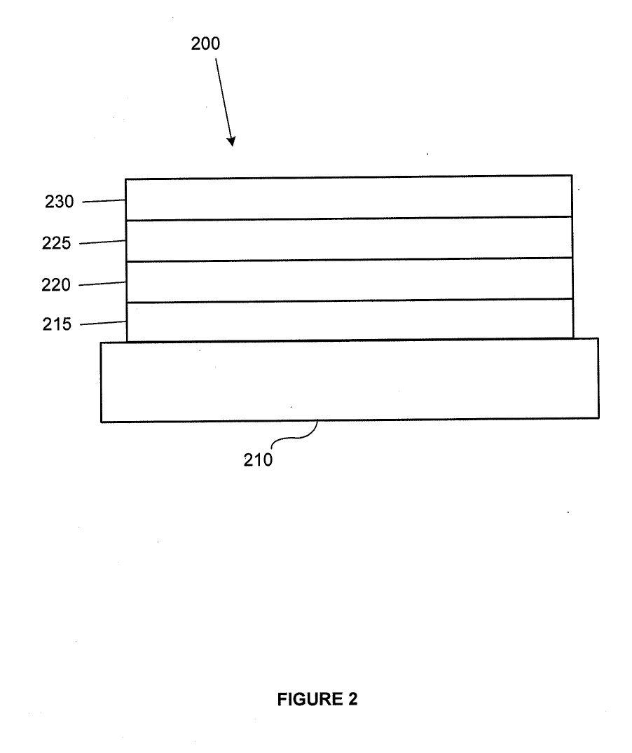

FIG. 2 shows an inverted OLED 200. The device includes a substrate 210, a cathode 215, an emissive layer 220, a hole transport layer 225, and an anode 230. Device 200 may be fabricated by depositing the layers described, in order. Because the most common OLED configuration has a cathode disposed over the anode, and device 200 has cathode 215 disposed under anode 230, device 200 may be referred to as an “inverted” OLED. Materials similar to those described with respect to device 100 may be used in the corresponding layers of device 200. FIG. 2 provides one example of how some layers may be omitted from the structure of device 100.

The simple layered structure illustrated in FIGS. 1 and 2 is provided by way of non-limiting example, and it is understood that aspects of the invention may be used in connection with a wide variety of other structures. The specific materials and structures described are exemplary in nature, and other materials and structures may be used. Functional OLEDs may be achieved by combining the various layers described in different ways, or layers may be omitted entirely, based on design, performance, and cost factors. Other layers not specifically described may also be included. Materials other than those specifically described may be used. Although many of the examples provided herein describe various layers as comprising a single material, it is understood that combinations of materials, such as a mixture of host and dopant, or more generally a mixture, may be used. Also, the layers may have various sublayers. The names given to the various layers herein are not intended to be strictly limiting. For example, in device 200, hole transport layer 225 transports holes and injects holes into emissive layer 220, and may be described as a hole transport layer or a hole injection layer. In one aspect, an OLED may be described as having an “organic layer” disposed between a cathode and an anode. This organic layer may comprise a single layer, or may further comprise multiple layers of different organic materials as described, for example, with respect to FIGS. 1 and 2.

Structures and materials not specifically described may also be used, such as OLEDs comprised of polymeric materials (PLEDs) such as disclosed in U.S. Pat. No. 5,247,190 to Friend et al., which is incorporated by reference in its entirety. By way of further example, OLEDs having a single organic layer may be used. OLEDs may be stacked, for example as described in U.S. Pat. No. 5,707,745 to Forrest et al, which is incorporated by reference in its entirety. The OLED structure may deviate from the simple layered structure illustrated in FIGS. 1 and 2. For example, the substrate may include an angled reflective surface to improve out-coupling, such as a mesa structure as described in U.S. Pat. No. 6,091,195 to Forrest et al., and/or a pit structure as described in U.S. Pat. No. 5,834,893 to Bulovic et al., which are incorporated by reference in their entireties.

Unless otherwise specified, any of the layers of the various aspects may be deposited by any suitable method. For the organic layers, preferred methods include thermal evaporation, ink-jet, such as described in U.S. Pat. Nos. 6,013,982 and 6,087,196, which are incorporated by reference in their entireties, organic vapor phase deposition (OVPD), such as described in U.S. Pat. No. 6,337,102 to Forrest et al., which is incorporated by reference in its entirety, and deposition by organic vapor jet printing (OVJP), such as described in U.S. patent application Ser. No. 10/233,470, which is incorporated by reference in its entirety. Other suitable deposition methods include spin coating and other solution based processes. Solution based processes are preferably carried out in nitrogen or an inert atmosphere. For the other layers, preferred methods include thermal evaporation. Preferred patterning methods include deposition through a mask, cold welding such as described in U.S. Pat. Nos. 6,294,398 and 6,468,819, which are incorporated by reference in their entireties, and patterning associated with some of the deposition methods such as ink-jet and OVJD. Other methods may also be used. The materials to be deposited may be modified to make them compatible with a particular deposition method. For example, substituents such as alkyl and aryl groups, branched or unbranched, and preferably containing at least 3 carbons, may be used in small molecules to enhance their ability to undergo solution processing. Substituents having 20 carbons or more may be used, and 3-20 carbons is a preferred range. Materials with asymmetric structures may have better solution processability than those having symmetric structures, because asymmetric materials may have a lower tendency to recrystallize. Dendrimer substituents may be used to enhance the ability of small molecules to undergo solution processing.

Devices fabricated in accordance with aspects of the invention may be incorporated into a wide variety of consumer products, including flat panel displays, computer monitors, televisions, billboards, lights for interior or exterior illumination and/or signaling, heads up displays, fully transparent displays, flexible displays, laser printers, telephones, cell phones, personal digital assistants (PDAs), laptop computers, digital cameras, camcorders, viewfinders, micro-displays, vehicles, a large area wall, theater or stadium screen, or a sign. Various control mechanisms may be used to control devices fabricated in accordance with the present invention, including passive matrix and active matrix. Many of the devices are intended for use in a temperature range comfortable to humans, such as 18 degrees C. to 30 degrees C., and more preferably at room temperature (20-25 degrees C.).

The materials and structures described herein may have applications in devices other than OLEDs. For example, other optoelectronic devices such as organic solar cells and organic photodetectors may employ the materials and structures. More generally, organic devices, such as organic transistors, may employ the materials and structures.

The terms halo, halogen, alkyl, cycloalkyl, alkenyl, alkynyl, arylkyl, heterocyclic group, aryl, aromatic group, and heteroaryl are known to the art, and are defined in U.S. Pat. No. 7,279,704 at cols. 31-32, which are incorporated herein by reference.

New materials are provided for use in an OLED, comprising a 1,3-bis(2-pyridylimino)isoindoline (BPI) transition metal or lanthanide complex. Particularly, the (BPI)PtCl complexes may be used as blue light emitters in OLEDs.

The primary focus of organic light emitting device research has been on the visible region of the spectrum (400-700 nm) for obvious display applications. However, the potential for such devices being applied to laser technology, optical sensors, biological/medicinal applications and others has resulted in a transition to creating and understanding near infrared (nIR) devices (700-2500 nm). The simplest method for shifting from red to nIR emission is to take current red emitting materials and modify them in a way that lowers the emission energy. To achieve the largest hypochromic shift it is common practice to extend the conjugation of known deep red emitters through benzannulation.

Recently, research into possible nIR phosphorescent small molecules for use in OLEDs has uncovered a unique system where the commonly accepted idea of benzannulation leading to red shifted emission does not hold. Particularly, the (BPI)PtCl group of emitters demonstrate the opposite trend, that is a >30 nm blue shift for each successive benzene ring addition. The development of improved blue emissive phosphorescent dopants remains an underdeveloped area in OLED research. While phosphorescent OLED devices with emission peaks in the deep blue or near-UV have been demonstrated, these devices often have poor properties that must be improved for most commercial applications. The development of novel blue emissive dopant materials, such as the (BPI)PtCl group of emitters, may play a major role in the highly sought after improvements in OLED properties.

1,3-bis(2-pyridylimino)isoindoline (BPI) was originally synthesized in 1952 in two steps and later one step. Elvidge, J. A., Linstead, R. P. J. Chem. Soc. 1952, 5000. Clark, P. F., Elvidge, J. A., Linstead, R. P., J. Chem. Soc. 1953, 3593. The production of gram scale quantities required harsh reaction conditions and as a results produced many side reactions including formation of phthalocyanine and related chromophoric by-products. It was not until the metal ion catalyzed reaction shown in FIG. 1 published by Siegl in 1977 that the BPI ligand became a viable option for research into the tridentate ligands interaction with transition metals. Siegl, W. O. J. Org. Chem. 1977, 42, 1872-1878.

The BPI ligand is interesting for many types of research because it is easy to prepare, is highly stable and can be easily modified to suit a particular interest. Examples of this include Siegl's later work producing water soluble derivatives, BPI derivatives capable of chelating two or even three metal ions and derivatives with extended conjugation. Siegl, W. O. J. Heterocycl. Chem. 1981, 18, 1613. Siegl, W. O. Inorg. Chem. Acta 1977, 25, L65. Marks, D. N.; Siegl, W. O.; Gangne, R. R. Inorg. Chem. 1982, 21, 3140-3147. Anderson, O. P.; la Cour, A. Dodd, A.; Garrett, A. D.; Wicholas, M. Inorg. Chem. 2003, 42, 122-127. Baird, D. M.; Maehlmann, W. P.; Bereman, R. D.; Singh, P. J. Coord. Chem. 1997, 42, 107-126.

The bulk of the research into using BPI ligand with first and second-row transition metals is as a potential catalyst. Examples include the use of a Co(III) alkylperoxy complex for the oxidation of hydrocarbons (Saussine, L.; Brazi, E.; Robine, A.; Mimoun, H.; Fischer, J.; Weiss, R. J. Amer. Chem. Soc. 1985, 107, 3534), ruthenium complexes for the oxidation of primary and secondary alcohols to aldehydes or ketones (Tolman, C. A.; Druliner, J. D.; Kirusic, P. J.; Nappa, M. J.; Seidel, W. C.; Williams, I. D.; Ittel, S. D. J. Mol. Catal. 1988, 48, 129) and others (Gagne, R. R.; Gall, R. S.; Lisensky, G. C.; Marsh, R. E.; Speltz, L. M. Inorg. Chem. 1979, 18, 771). This catalytic research led to the discovery of many interesting coordination complexes. Addison, A. W.; Burke, P. J.; Henrick, P. J.; Henrick, K. Inorg. Chem. 1982, 21, 60. Bautista, D. V.; Dewan, J. C.; Thompson, J. C.; Thompson, L. K. J. Heterocyclic Chem. 1983, 20, 345.

Another application of the BPI ligand is in the field of biology and biochemistry. The goal of most of this research is to mimic naturally occurring biological enzymes with BPI transition metal complexes. The enzymes of interest include galactose oxidase enzymes (Bereman, R. D.; Shields, G. D.; Dorfman, J. R.; Bordner, J. J. Inorg. Biochem. 1983, 19, 75), manganese catalases (Kaizer, J.; Barath, G.; Speier, G.; Reglier, M.; Giorgi, M. Inorg. Chem. Comm. 2007, 10, 292) and queretin dioxygenase (Balogh-Hergovich, E.; Kaizer, J.; Speier, G.; Huttner, G.; Jacobi, A. Inorg. Chem. 2000, 39, 4224). Another more recent application was the interaction of cobalt(III)(BPI)₂ complex with calf-thymus DNA in an effort to develop novel non-radioactive probes of DNA structure (Selvi, P. T.; Stoeckli-Evans, H.; Palaniandavar, M. J. Inorg. Biochem. 2005, 99, 2110-2118).

Most of the above mentioned research focuses on first row transition metals such a manganese, iron, cobalt, nickel, copper and zinc. The research into BPI third row transition metal complexes is limited to complexes of palladium (Baird, D. M.; Maehlmann, W. P.; Bereman, R. D.; Singh, P. J. Coord. Chem. 1997, 42, 107-126; Broring, M.; Kleeberg, C. Inorg. Chem. Acta 2007, 360, 3281; Meder, M.; Galka, C. H.; Gade, L. H. Monatshefte für Chemie 2005, 136, 1693-1706), ruthenium (Marks, D. N.; Siegl, W. O.; Gangne, R. R. Inorg. Chem. 1982, 21, 3140-3147) and molybdenum (Baird, D. M.; Maehlmann, W. P.; Bereman, R. D.; Singh, P. J. Coord. Chem. 1997, 42, 107-126; Baird, D. M.; Hassan, R.; Kim, W. K.; Inorg. Chem. Acta 1987, 130, 39; Baird, D. M.; Shih, K. Y.; Welch, J. H.; Bereman, R. D. Polyhedron 1989, 8, 2359; Baird, D. M.; Shih, K. Y. Polyhedron 1991, 10, 229). There is only one report to date of a third row transition metal BPI complex ((BPI)PtCl) and can be found as a side note to research on second row transition complexes (Meder, M.; Galka, C. H.; Gade, L. H. Monatshefte für Chemie 2005, 136, 1693-1706).

Despite the extensive amount of research into BPI transition metal and lanthanide complexes there are no reports of the emissive properties of this class of materials. Herein, the synthesis and emission of (BPI)PtCl and its derivatives are provided as a new class of materials for use as a triplet emitting dopant in organic light emitting diodes OLEDs.

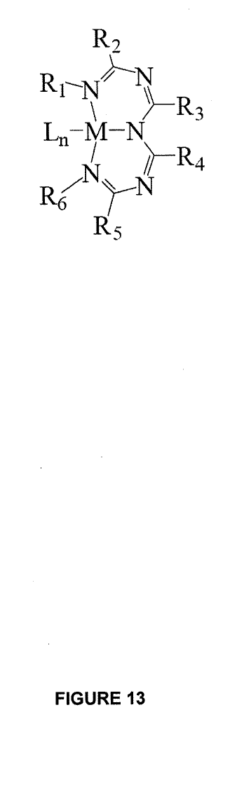

As shown in FIG. 13, a new class of materials are provided, which may be used in OLEDs, including an emissive complex having formula I:

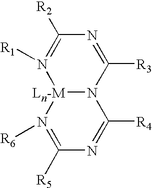

wherein M is a transition metal or a lanthanide;
wherein n is 0, 1, 2, 3, 4, 5, or 6;
wherein there are n independently selected ligands L;
wherein L is a monodentate, bidentate, or tridentate ligand;
wherein each of R₁, R₂, R₃, R₄, R₅, and R₆ is independently selected from the group consisting of hydrogen, alkyl, aryl, heteroaryl;
wherein one or more of R₁, R₂, R₃, R₄, R₅, and R₆ may be linked; and
wherein at least one of the pairs R₁ and R₂, R₃ and R₄, R₅ and R₆ is linked to form a cyclic group.

Preferably, the complex has a transition metal and may have a coordination number wherein n is 1, 2, 3, or 4. Preferably, the complex has a lanthanide and may have a coordination number wherein n is 1, 2, 3, 4, 5 or 6. For a lanthanide, a complex where n is 1, 2, 3, 4, or 5 is preferred.

Preferably, the complex may have non-hydrogen substituent at R₁ and R₆, which may provide improved complex stability.

In an aspect, the materials include a complex, wherein each of the pairs R₁ and R₂, R₃ and R₄, and R₅ and R₆ are linked to form a cyclic group, and the complex may have one of the following formulas:

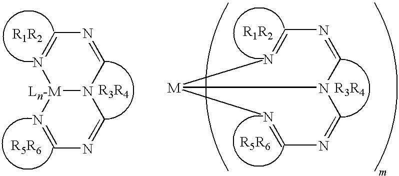

A complex having each of the pairs R₁ and R₂, R₃ and R₄, and R₅ and R₆ linked is preferable because it may have an improved synthesis and stability.

In an aspect, the materials include a complex wherein M is Pt.

In an aspect, the complex has at least 1 additional aryl or heteroaryl fused to the pair R₁ and R₂, R₃ and R₄, and R₅ and R₆ that is linked to form a cyclic group.

In an aspect, the complex has the formula:

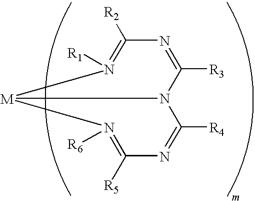

wherein m is 1, 2, or 3. Preferably, the materials include a complex wherein m is 2 or 3.

In an aspect, the pair R₃ and R₄ linked to form a cyclic group. In a particular aspect, the pair R₃ and R₄ is a hydrocarbon group, illustrated as attached to the nitrogen and carbon atoms of the complex, selected from the group consisting of:

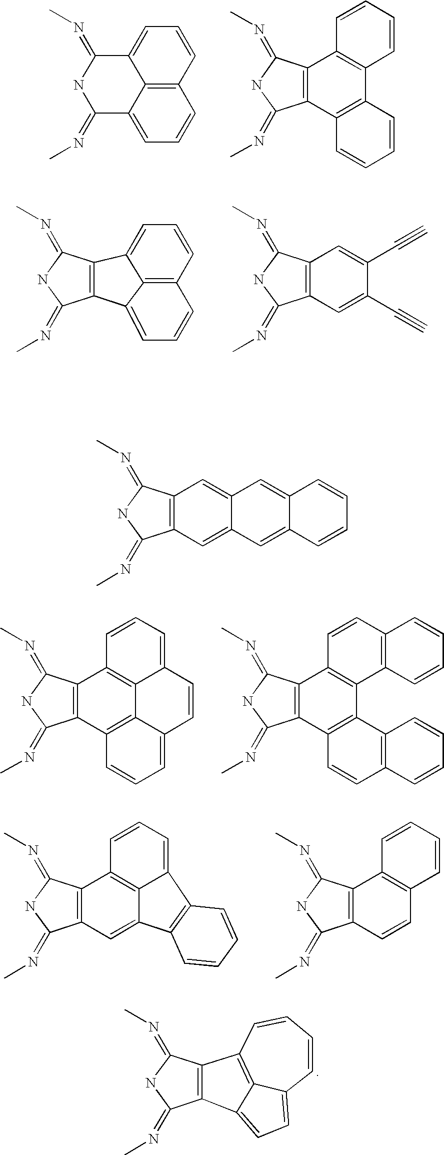

In an aspect, the pair R₃ and R₄ is linked to form a cyclic group, illustrated as attached to the nitrogen and carbon atoms of the complex, selected from the group consisting of:

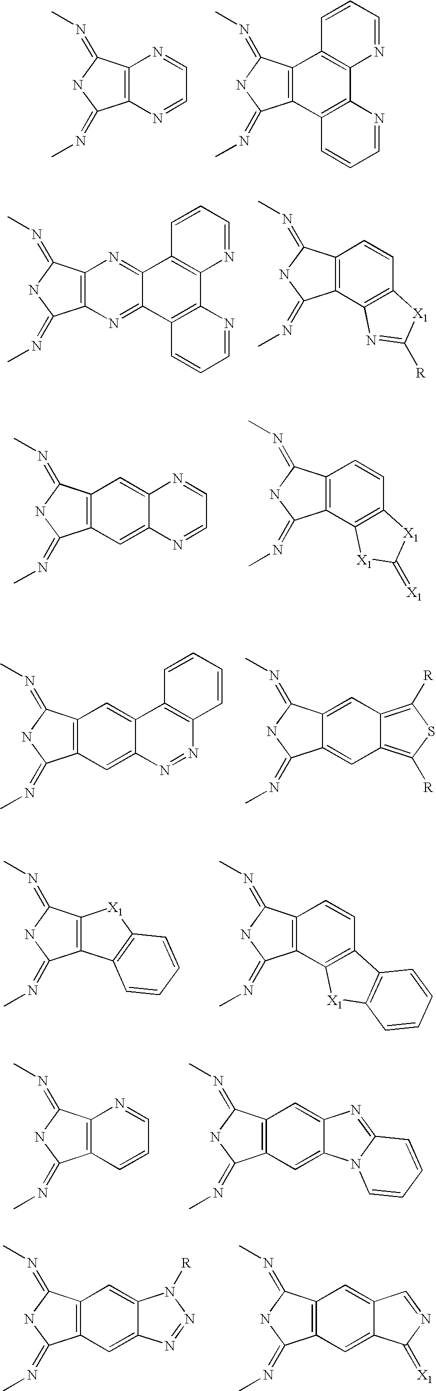

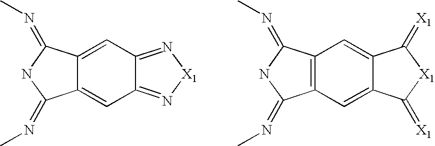

wherein X₁ is selected from the group consisting of S, O, and NR, where R is any alkyl group or hydrogen. These definitions of X₁ and R apply throughout.

In an aspect, the pair R₁ and R₂ linked to form a cyclic group. In a particular aspect, the pair R₁ and R₂ is a heteroatomic group, illustrated as attached to the nitrogen and carbon atoms of the complex, selected from the group consisting of:

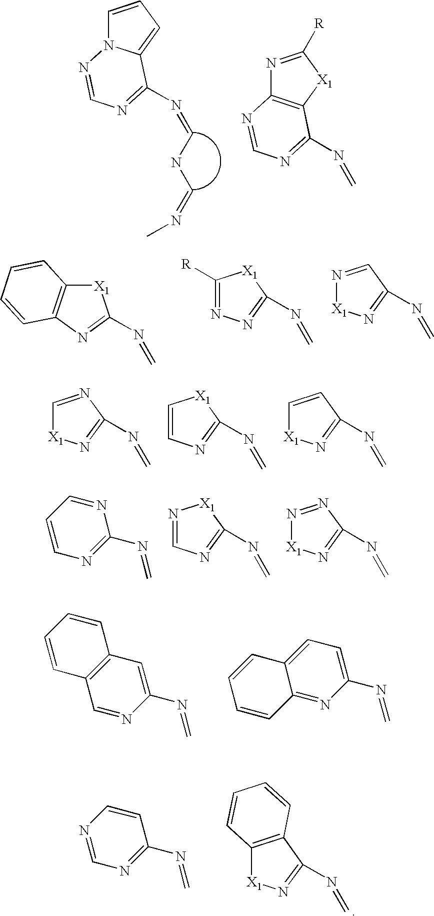

In an aspect, each of the pairs R₁ and R₂, and R₅ and R₆ are linked to form a cyclic group. In a particular aspect, each of the pairs R₁ and R₂, and R₅ and R₆ are a heteroatomic group, illustrated as attached to the nitrogen and carbon atoms of the complex, selected from the group consisting of:

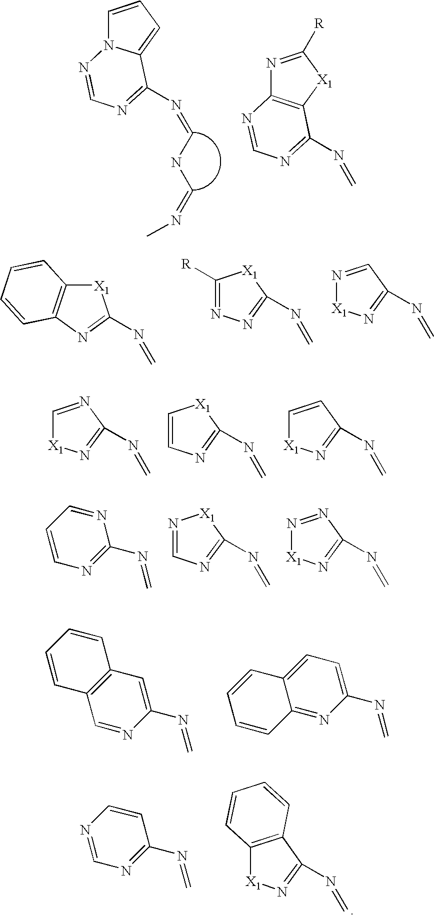

In an aspect, each of the pairs R₁ and R₂, and R₅ and R₆, illustrated as attached to the nitrogen and carbon atoms of the complex, are independently selected from the group consisting of:

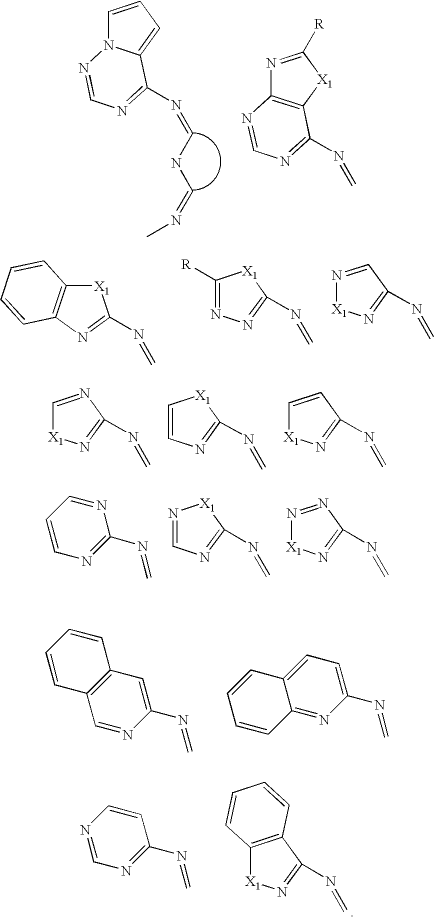

In an aspect, the pair R₃ and R₄ is linked to form a cyclic group to which multiple metals are coordinated. In a particular aspect, the pair R₃ and R₄, illustrated as attached to the nitrogen and carbon atoms of the complex, is selected from the group consisting of:

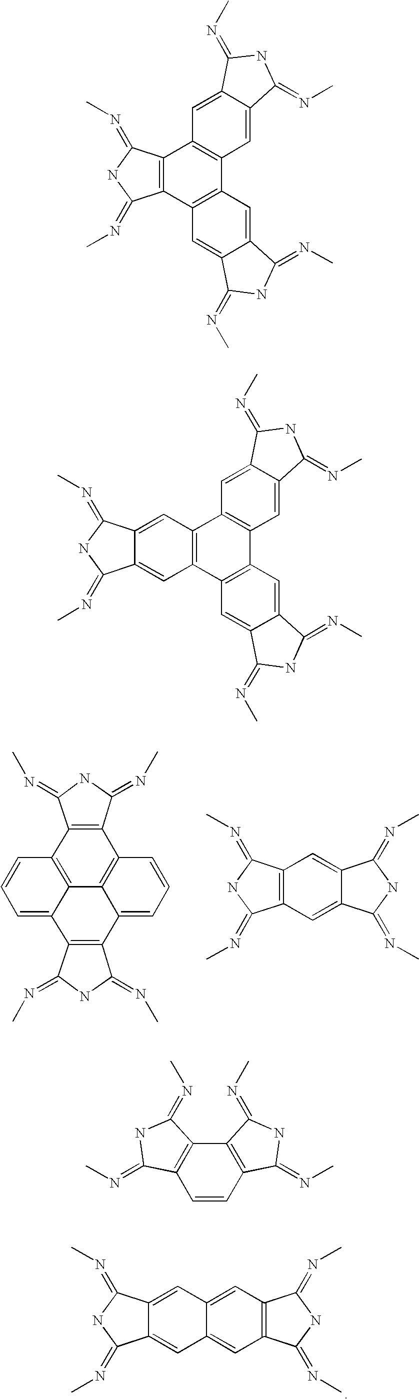

Additionally, an organic light emitting device is provided. The device comprises an anode, a cathode and an organic emissive layer, disposed between the anode and the cathode. In a particular aspect, the device comprises a material containing a complex where each of the pairs R₁ and R₂, R₃ and R₄, and R₅ and R₆ are linked to form a cyclic compound. The organic layer further comprises a host and an emissive dopant, wherein a complex having formula I is the emissive dopant. Any of the more specific complexes described in the above paragraphs that meet formula I may be used in an OLED.

### Experimental

Ligand Synthesis/Absorption:

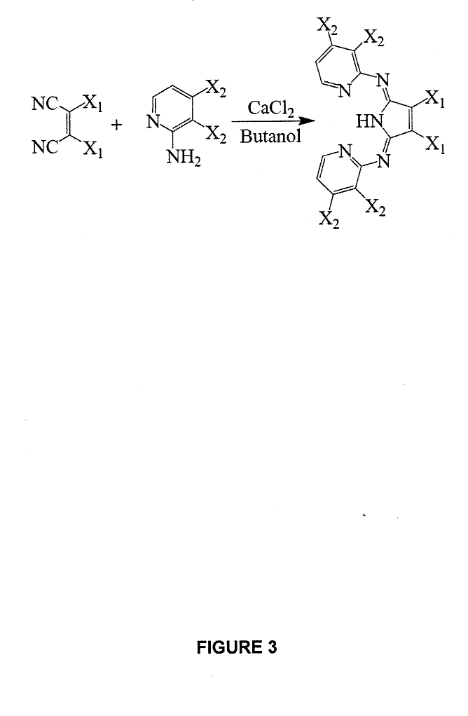

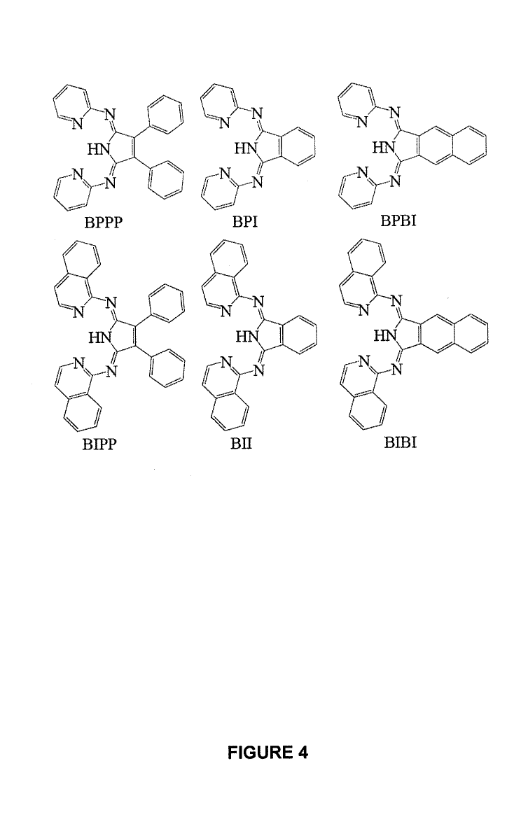

All ligands were synthesized with the same general procedure as reported in literature and can be seen in FIG. 3. Siegl, W. O. J. Org. Chem. 1977, 42, 1872-1878; Baird, D. M.; Maehlmann, W. P.; Bereman, R. D.; Singh, P. J. Coord. Chem. 1997, 42, 107-126. The general synthesis goes as follows: 1 equivalent dicyano species, 2.1 equivalents aminopyridine/isoquinoline and 0.1 equivalents CaCl₂ were refluxed in butanol under N₂. Reaction completion was determined by monitoring the UV-Vis spectra of the reaction. Upon cooling, the precipitate was collected by filtration and washed with water. Ligands that were synthesized by this method can be seen in FIG. 4.

Diphenylfumaronitrile:

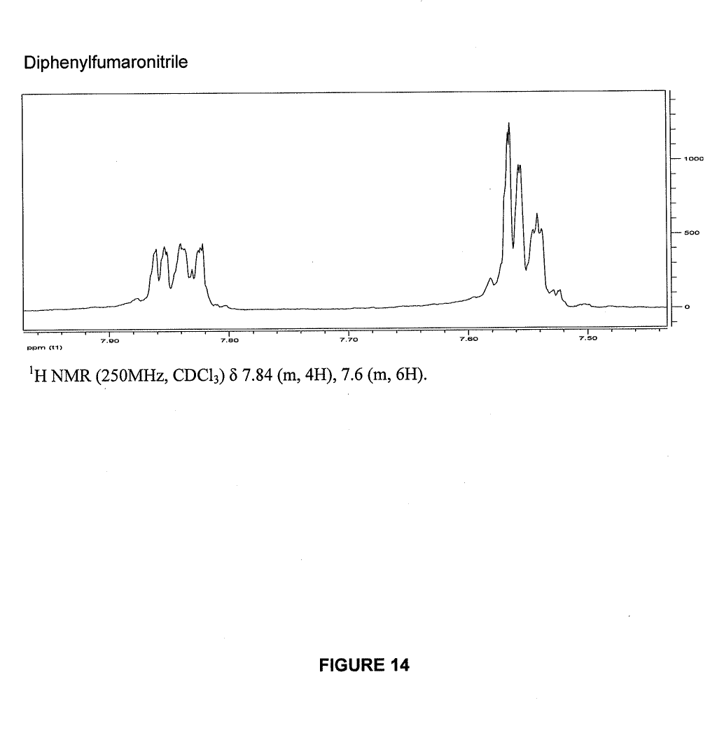

Yeh, H.; Wu, W.; Wen, Y.; Dai, D.; Wang, J.; Chen, C. J. Org. Chem. 2004, 69, 6455-6462 provides useful information. 11.5 ml phenylacetonitrile (100 mmol) and 25.38 g iodine (100 mmol) were dissolved in 90 ml dry diethyl ether under N₂. The solution was then cooled to −78° C. using a dry ice acetone bath. To this solution, 11.89 g sodium methoxide (220 mmol) in 200 ml methanol was added drop wise via cannula over 1 hour. Upon completion the acetone dry ice bath was replaced with an ice-water bath. The solution was allowed to stir at 0° C. for 4 hours. The mixture was then quenched with 10 ml or 3-4% HCl solution. The solid was isolated by filtration and rinsed with cold methanol and water. 3.05 g (26.5%), off-white solid. The structure of diphenylfumaronitrile was confirmed using ¹H NMR spectroscopy, as illustrated in FIG. 14.

### 2,5-bis(2-pyridylimino)-3,4-diphenylpyrrole (BPPP)

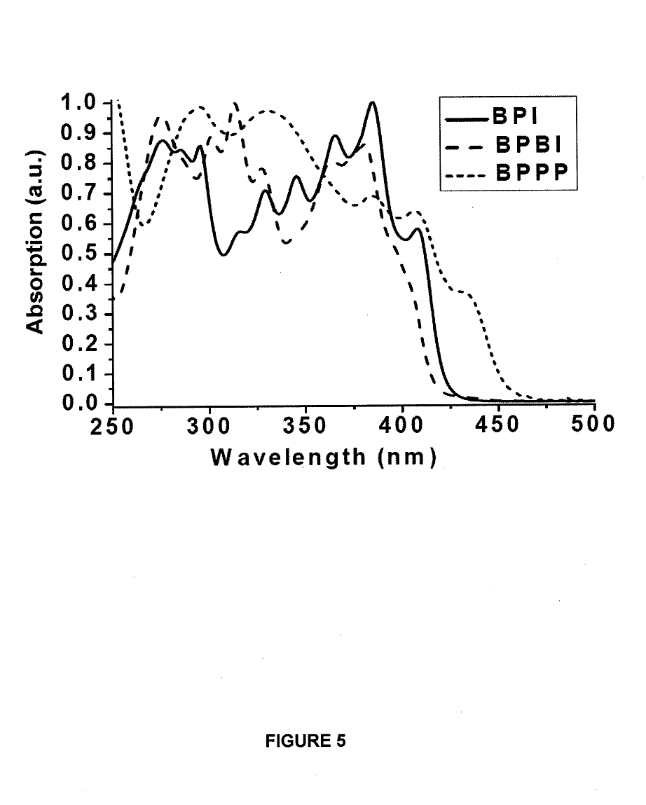

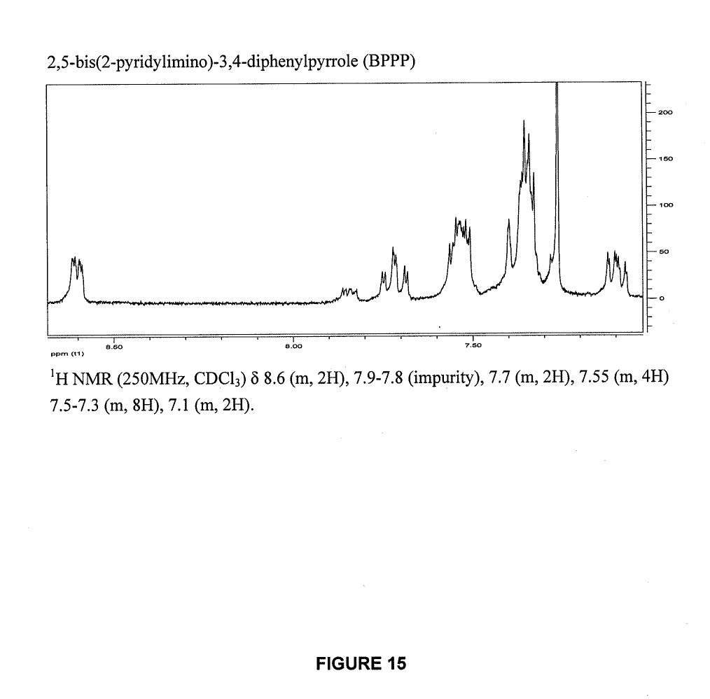

A solution of 0.5 g diphenylfumaronitrile (2.16 mmol), 0.428 g 2-aminopyridine (4.56 mmol) and 0.05 g CaCl₂ (0.5 mmol) in 10 ml 1-butanol was refluxed under N₂ for 15 days. Upon cooling to room temperature, product began to precipitate out of solution. The precipitate was collected by filtration, washed with water and used for the next step without further purification. 0.39 g (45%), dark green solid. Absorption spectra in CH₂Cl₂ can be seen in FIG. 5. The structure of BPPP was confirmed using ¹H NMR spectroscopy, as illustrated in FIG. 15.

### 1,3-bis(2-pyridylimino)isoindole (BPI)

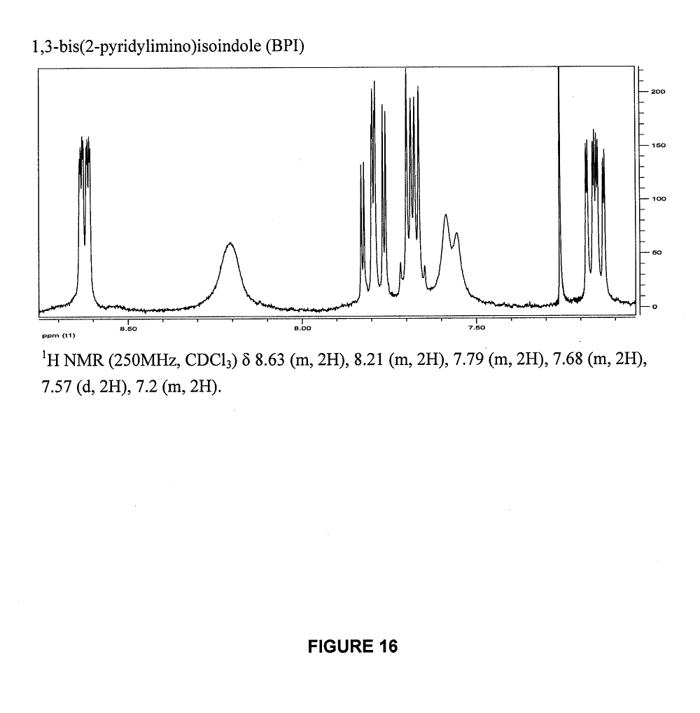

Siegl, W. O. J. Org. Chem. 1977, 42, 1872-1878 provides useful information. A solution of 1.28 g 1,2-dicyanobenzene (10 mmol), 1.97 g 2-aminopyridine (21 mmol) and 0.11 g CaCl₂ (1 mmol) in 20 ml 1-butanol was refluxed under N₂ for 48 hours. Upon cooling to room temperature, product began to precipitate out of solution. The precipitate was collected by filtration, washed with water and recrystallized with ethanol/water. 2.02 g (67.5%), pale yellow needles. Absorption spectra in CH₂Cl₂ can be seen in FIG. 5. The structure of BPI was confirmed using ¹H NMR spectroscopy, as illustrated in FIG. 16.

### 1,3-bis(2-pyridylimino)benz(f)isoindole (BPBI)

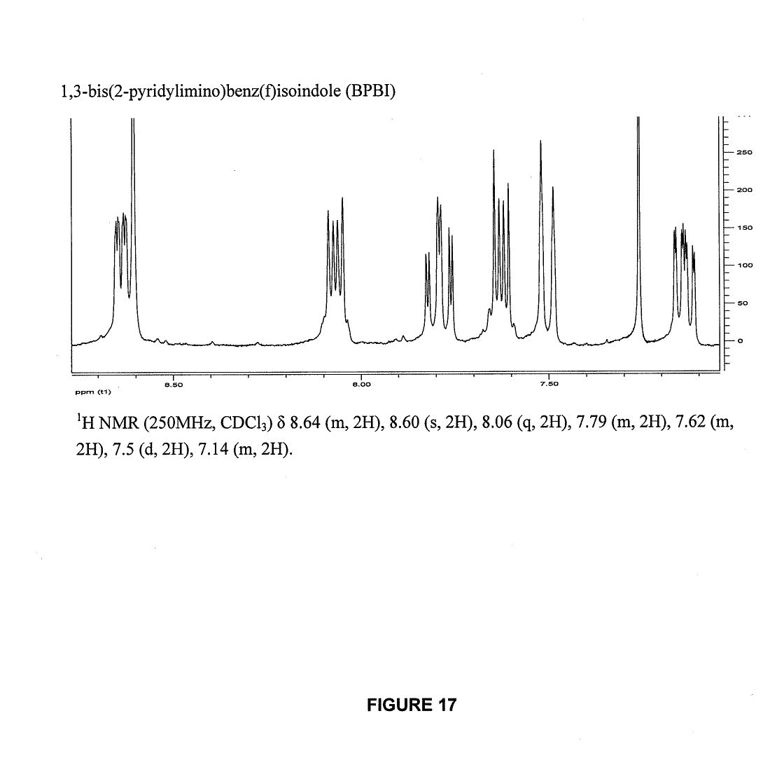

Baird, D. M.; Maehlmann, W. P.; Bereman, R. D.; Singh, P. J. Coord. Chem. 1997, 42, 107-126 provides useful information. A solution of 2 g 2,3-dicyanonaphthylene (11.2 mmol), 2.21 g 2-aminopyridine (23.5 mmol) and 0.124 g CaCl₂ (1.12 mmol) in 30 ml 1-butanol was refluxed under N₂ for 20 days. Upon cooling to room temperature, product began to precipitate out of solution. The precipitate was collected by filtration, washed with water and recrystallized with 100 ml ethanol/water (1:1). 3.07 g (78.5%), pale yellow/brown solid. Absorption spectra in CH₂Cl₂ can be seen in FIG. 5. The structure of BPBI was confirmed using ¹H NMR spectroscopy, as illustrated in FIG. 17.

### 2,5-bis(1-isoquinolylimino)-3,4-diphenylpyrrole (BIPP)

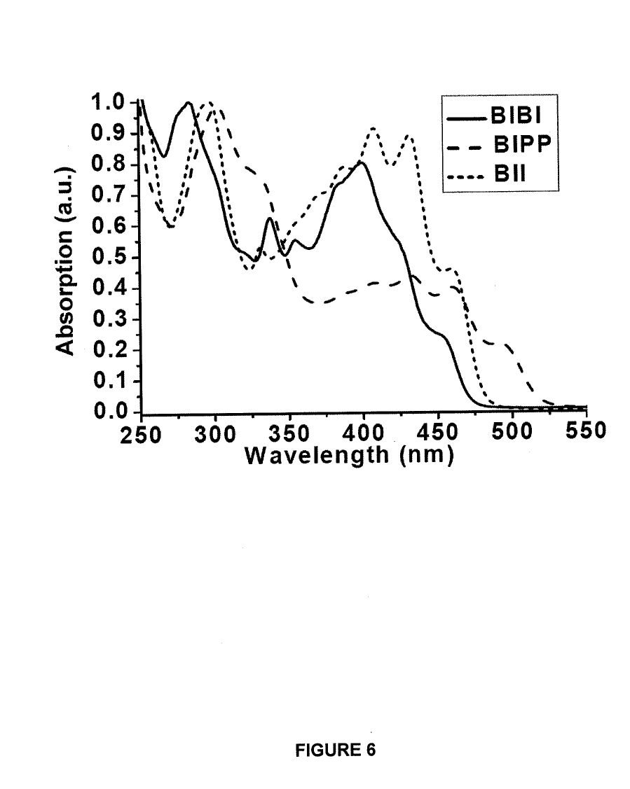

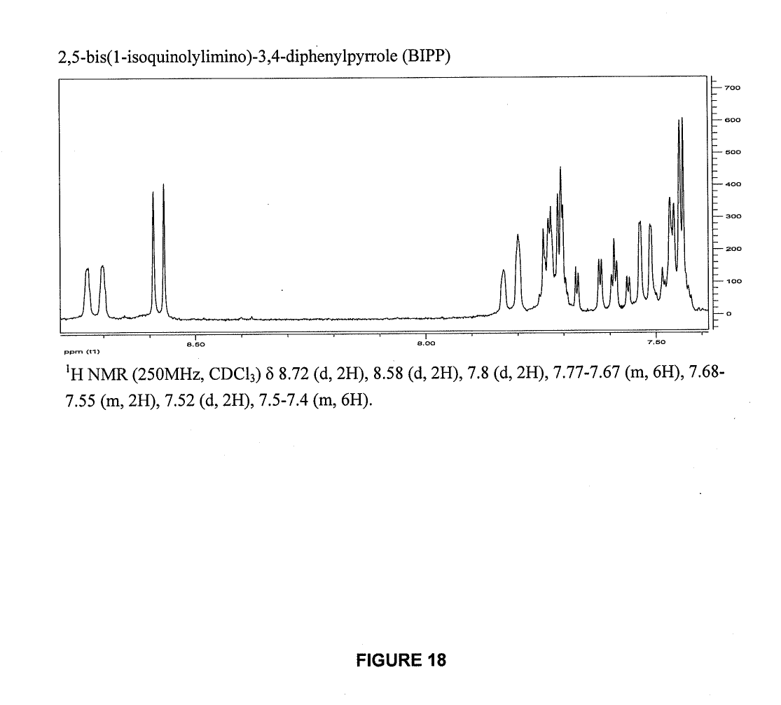

A solution of 0.5 g diphenylfumaronitrile (2.16 mmol), 0.663 g 1-aminoisoquinoline (4.56 mmol) and 0.05 g CaCl₂ (0.5 mmol) in 15 ml 1-butanol was refluxed under N₂ for 10 days. Upon cooling to room temperature, product began to precipitate out of solution. The precipitate was collected by filtration, washed with water and used for the next step without further purification. 0.691 g (64%), black solid. Absorption spectra in CH₂Cl₂ can be seen in FIG. 6. The structure of BIPP was confirmed using ¹H NMR spectroscopy, as illustrated in FIG. 18.

### 1,3-bis(1-isoquinolylimino)isoindole (BII)

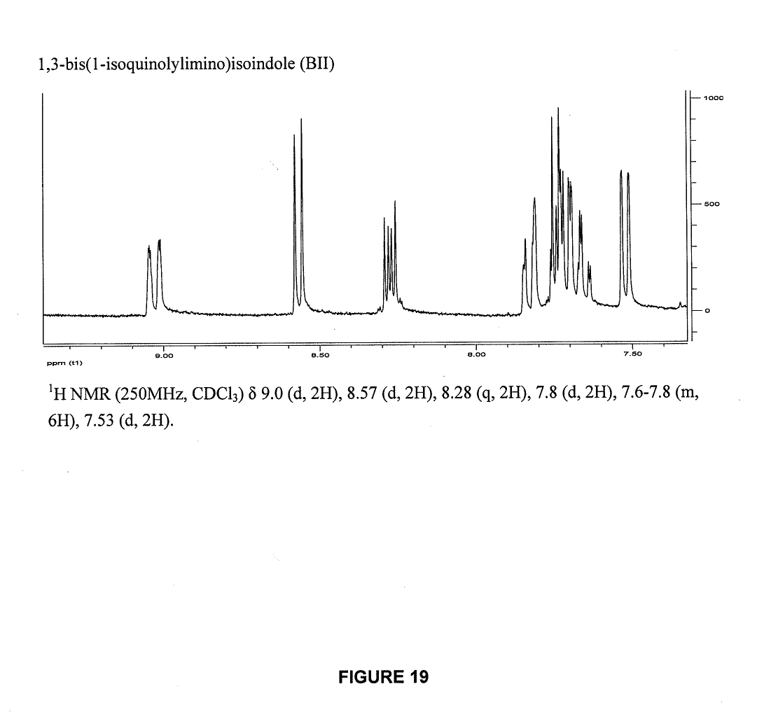

A solution of 0.421 g 1,2-dicyanobenzene (3.29 mmol), 1 g 1-aminoisoquinoline (6.9 mmol) and 0.11 g CaCl₂ (1 mmol) in 20 ml 1-butanol was refluxed under N₂ for 5 days. Upon cooling to room temperature, product began to precipitate out of solution. The precipitate was collected by filtration, washed with water and recrystallized with ethanol/water. 1.091 g (83%), green needles. Absorption spectra in CH₂Cl₂ can be seen in FIG. 6. The structure of BII was confirmed using ¹H NMR spectroscopy, as illustrated in FIG. 19.

### 1,3-bis(1-isoquinolylimino)benz(f)isoindole (BIBI)

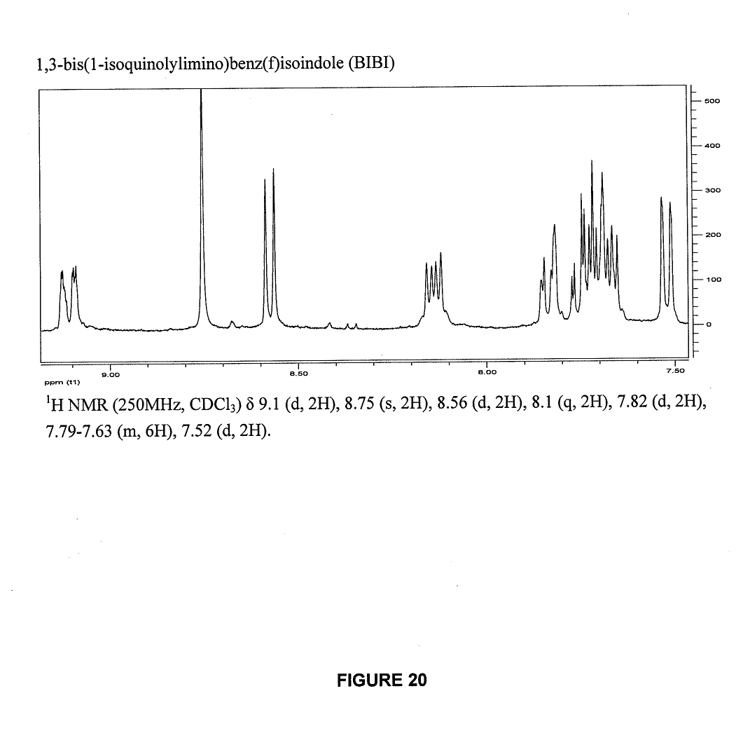

A solution of 0.385 g 2,3-dicyanonaphthylene (2.16 mmol), 0.663 g 1-aminoisoquinoline (4.557 mmol) and 0.05 g CaCl₂ (0.5 mmol) in 20 ml 1-butanol was refluxed under N₂ for 30 days. Upon cooling to room temperature, product began to precipitate out of solution. The precipitate was collected by filtration, washed with water. 0.781 g (80.5%), pale yellow/brown solid. Absorption spectra in CH₂Cl₂ can be seen in FIG. 6. The structure of BIBI was confirmed using ¹H NMR spectroscopy, as illustrated in FIG. 20.

Platinum Complex Synthesis/Absorption/Emission:

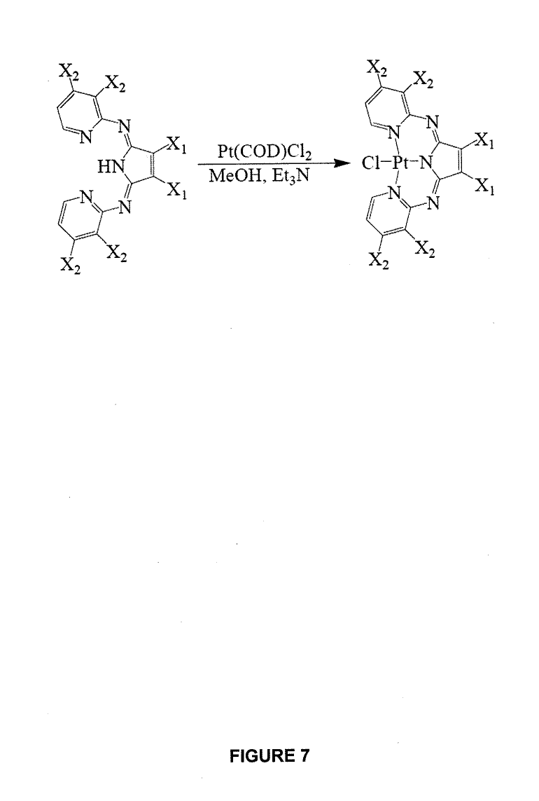

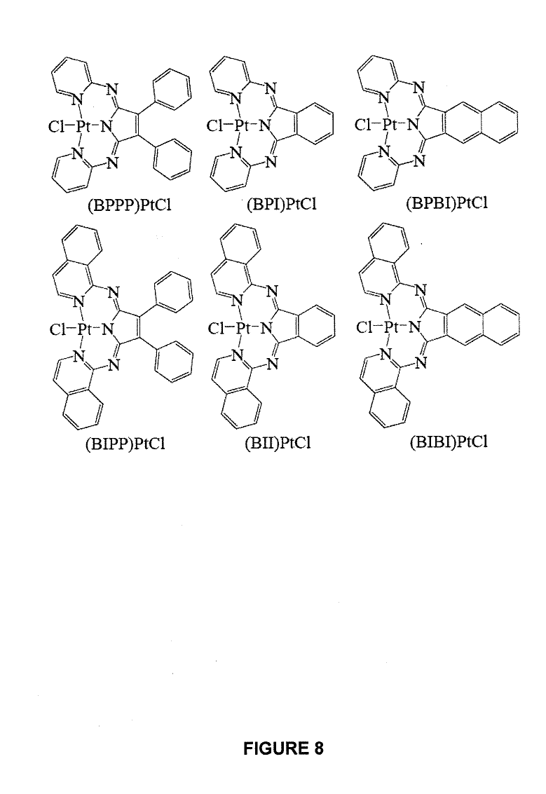

All platinum complex reactions follow the synthesis reported in literature by Meder, M.; Galka, C. H.; Gade, L. H. Monatshefte für Chemie 2005, 136, 1693-1706 and can be seen in FIG. 7. The general synthesis goes as follows: 1 equivalent ligand and 1.1 equivalents of Dichloro(1,5-cyclooctadiene)platinum(II) were suspended in methanol followed by the addition of 1.1 equivalents of triethylamine. The solution was then heated to 50° C. under nitrogen for 24 hours. Upon cooling the precipitate was collected by filtration and washed with water. Platinum complexes synthesized by this method can been seen in FIG. 8.

### Dichloro(1,5-cyclooctadiene)platinum(II) ((COD)PtCl₂)

McDermott, J. X.; White, J. F.; Whitesides, G. M. J. Am. Chem. Soc. 1976, 69, 6521-6528 provides useful information. 2.5 g K₂PtCl₄ (6 mmol) was dissolved in 40 ml H₂O and filtered. To the deep red filtrate was added 60 ml glacial acetic acid followed by 2.5 ml cycloocta-1,5-diene (20 mmol). The reaction was heated to 90° C. and stirred under nitrogen for 30 min. During this time the solution turned from deep red to pale yellow as precipitate began to form. The solvent volume was reduced to 30 ml. The precipitate was then collected by filtration washed with water, ethanol and ether. The product was dried under vacuum overnight. 1.99 g (89%), pale off white solid was used for the next steps without further purification.

### 2,5-bis(2-pyridylimino)-3,4-diphenylpyrrolate platinum chloride ((BPPP)PtCl)

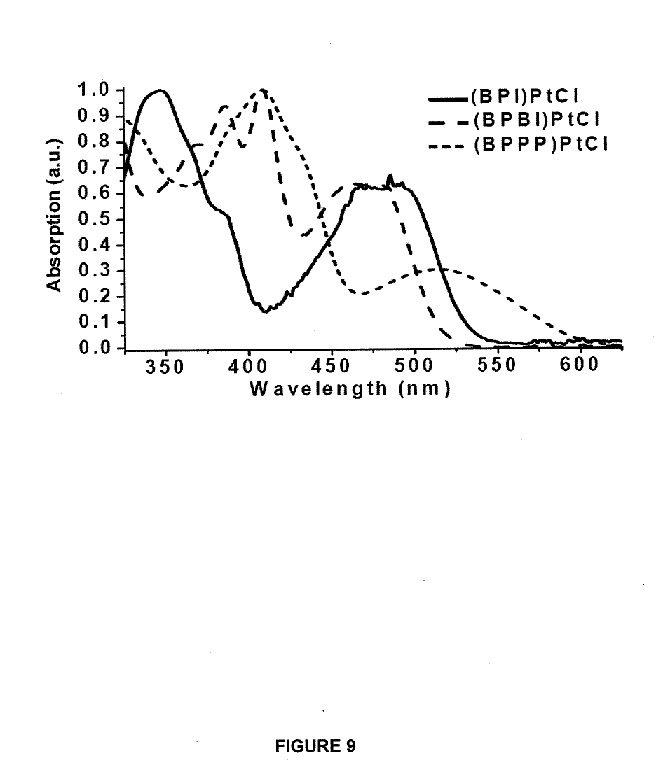

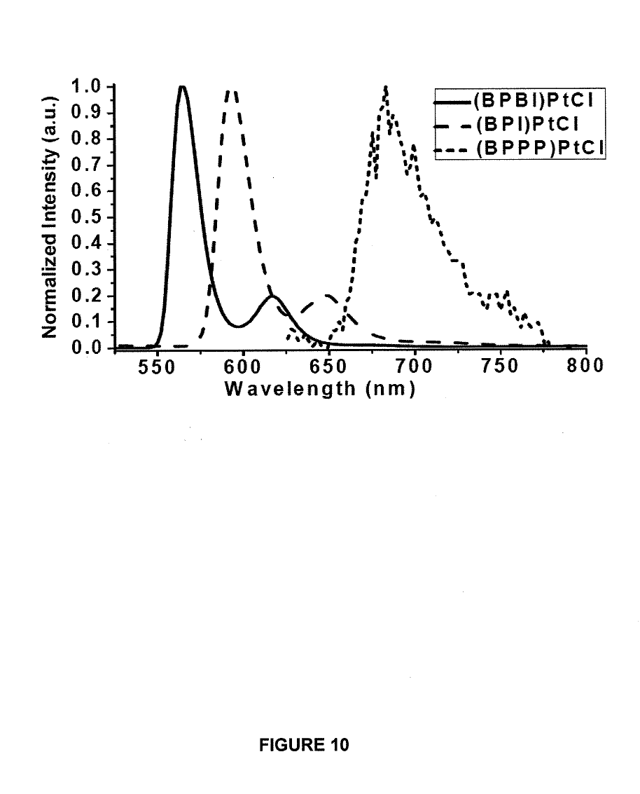

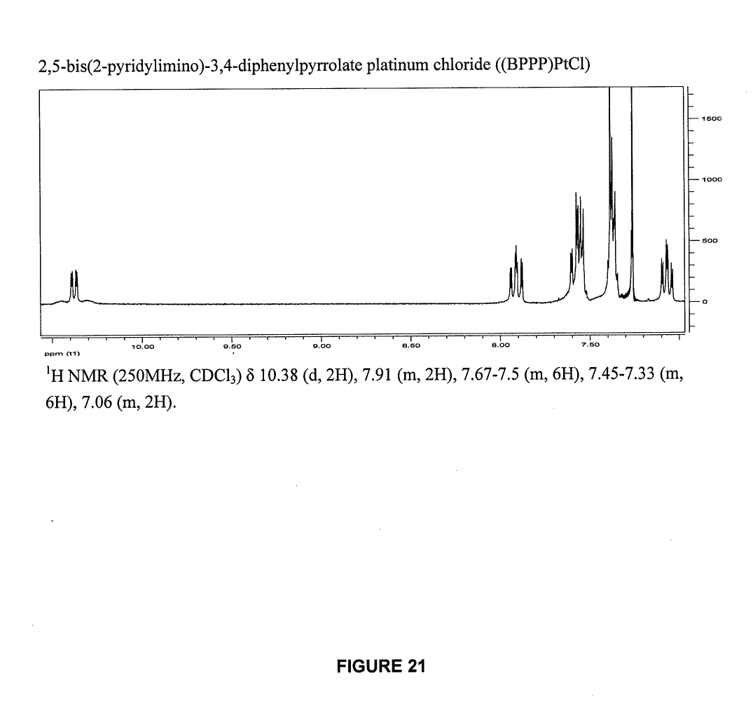

0.200 g (COD)PtCl₂ (0.536 mmol) and 0.199 g BPPP (0.496 mmol) were suspended in 15 ml of methanol. To this solution 0.074 ml triethylamine (0.536 mmol) was added and the solution was heated to 50° C. under nitrogen for 24 hours. Precipitate began to form upon cooling to room temperature. The precipitate was collected by filtration and washed with water. The product was then dried under vacuum overnight. 0.29 g (86%), deep red solid. Absorption spectra in CH₂Cl₂ can be seen in FIG. 9. Emission spectra in 2-methylTHF at 77K can be seen in FIG. 10. The structure of (BPPP)PtCL was confirmed using ¹H NMR spectroscopy, as illustrated in FIG. 21.

### 1,3-bis(2-pyridylimino)isoindolate platinum chloride ((BPI)PtCl)

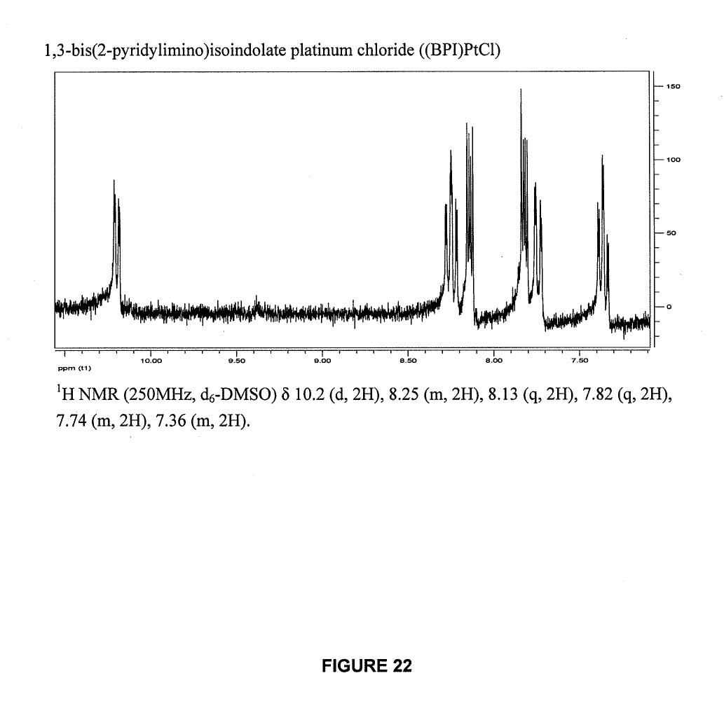

Meder, M.; Galka, C. H.; Gade, L. H. Monatshefte für Chemie 2005, 136, 1693-1706 provides useful information. 0.50 g (COD)PtCl₂ (1.34 mmol) and 0.37 g BPPP (1.24 mmol) were suspended in 25 ml of methanol. To this solution 0.186 ml triethylamine (1.34 mmol) was added and the solution was heated to 50° C. under nitrogen for 24 hours. Precipitate began to form upon cooling to room temperature. The precipitate was collected by filtration and washed with water. The product was then recrystallized with dichloromethane/hexane (1:1). 0.454 g (70%), bright orange solid. Absorption spectra in CH₂Cl₂ can be seen in FIG. 9. Emission spectra in 2-methylTHF at 77K can be seen in FIG. 10. The structure of (BPI)PtCL was confirmed using ¹H NMR spectroscopy, as illustrated in FIG. 22.

### 1,3-bis(2-pyridylimino)benz(f)isoindolate platinum chloride ((BPBI)PtCl)

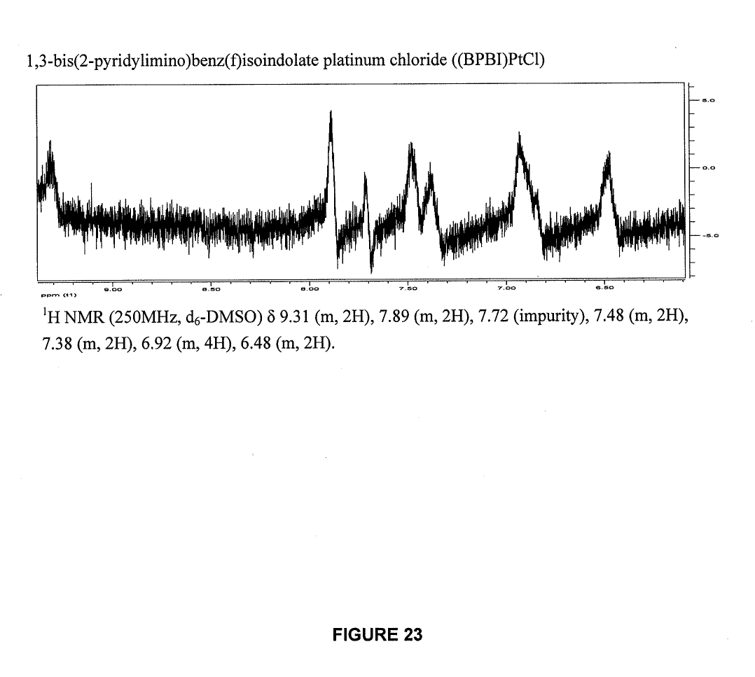

0.50 g (COD)PtCl₂ (1.34 mmol) and 0.433 g BPBI (1.24 mmol) were suspended in 25 ml of methanol. To this solution 0.186 ml triethylamine (1.34 mmol) was added and the solution was heated to 50° C. under nitrogen for 24 hours. Precipitate began to form upon cooling to room temperature. The precipitate was collected by filtration and washed with water. 0.554 g (78%), pale orange/brown solid. Absorption spectra in CH₂Cl₂ can be seen in FIG. 9. Emission spectra in 2-methylTHF at 77K can be seen in FIG. 10. The structure of (BPBI)PtCL was confirmed using ¹H NMR spectroscopy, as illustrated in FIG. 23.

### 2,5-bis(1-isoquinolylimino)-3,4-diphenylpyrrolate platinum chloride ((BIPP)PtCl)

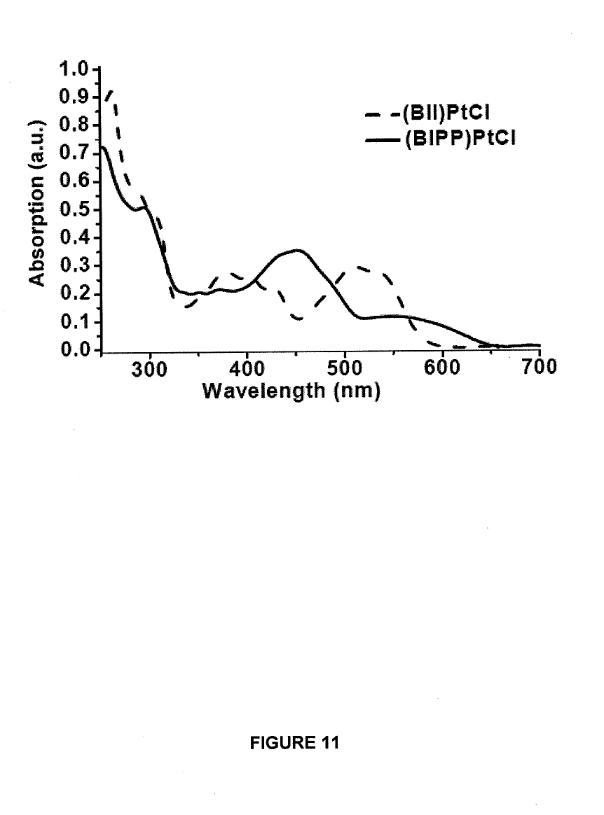

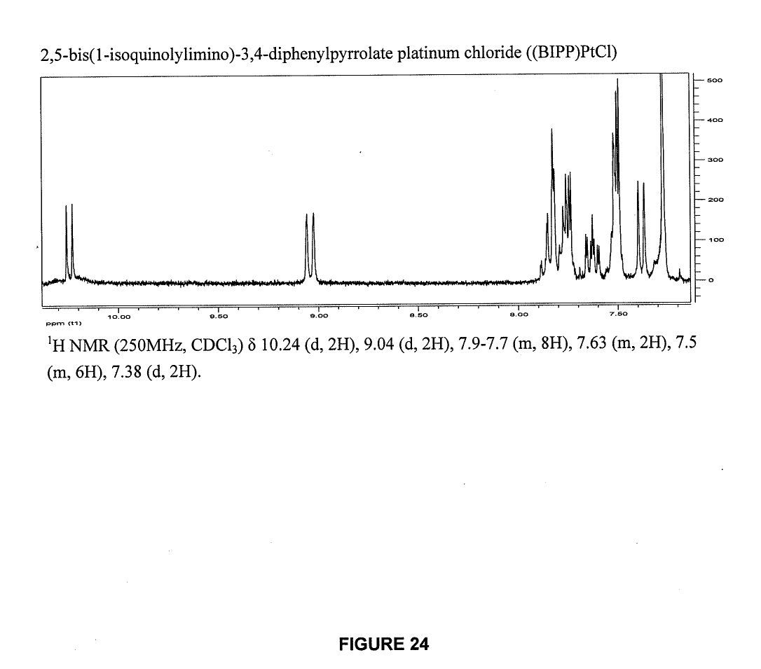

0.200 g (COD)PtCl₂ (0.536 mmol) and 0.391 g BPPP (0.496 mmol) were suspended in 15 ml of methanol. To this solution 0.074 ml triethylamine (0.536 mmol) was added and the solution was heated to 50° C. under nitrogen for 24 hours. Precipitate began to form upon cooling to room temperature. The precipitate was collected by filtration and washed with water. The product was then dried in oven overnight. 0.29 g (81%), dark green solid. Absorption spectra in CH₂Cl₂ can be seen in FIG. 11. The structure of (BIPP)PtCl was confirmed using ¹H NMR spectroscopy, as illustrated in FIG. 24

### 1,3-bis(1-isoquinolylimino)isoindolate platinum chloride ((BII)PtCl)

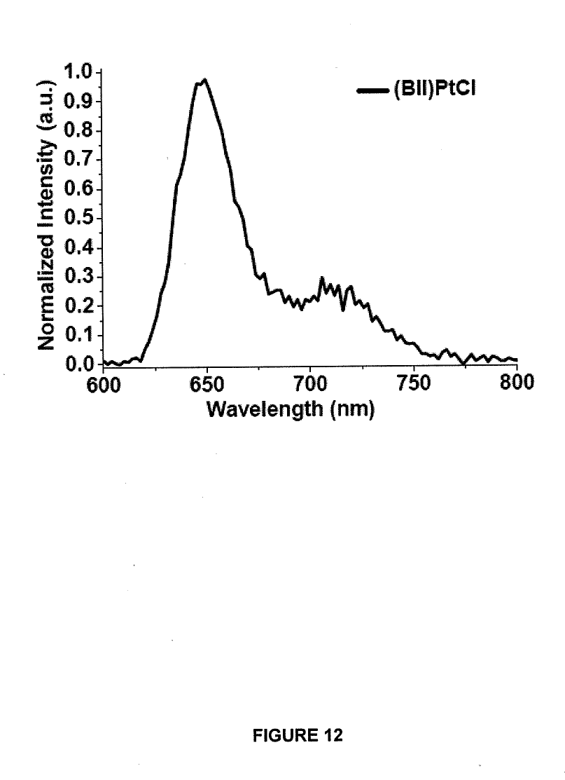

0.360 g (COD)PtCl₂ (0.965 mmol) and 0.356 g BII (0.893 mmol) were suspended in 20 ml of methanol. To this solution 0.134 ml triethylamine (0.965 mmol) was added and the solution was heated to 50° C. under nitrogen for 24 hours. Precipitate began to form upon cooling to room temperature. The precipitate was collected by filtration and washed with water. 0.505 g (90%), dark purple solid. Due to low solubility no NMR was taken. Absorption spectra in CH₂Cl₂ can be seen in FIG. 11. Emission spectra in 2-methylTHF at 77K can be seen in FIG. 12.

### 1,3-bis(1-isoquinolylimino)benz(f)isoindolate platinum chloride ((BIBI)PtCl)

0.360 g (COD)PtCl₂ (0.965 mmol) and 0.401 g BIBI (0.893 mmol) were suspended in 20 ml of methanol. To this solution 0.134 ml triethylamine (0.965 mmol) was added and the solution was heated to 50° C. under nitrogen for 24 hours. Precipitate began to form upon cooling to room temperature. The precipitate was collected by filtration and washed with water. 0.460 g (76%), dark solid. Due to low solubility no NMR was taken.

It is understood that the various aspects described herein are by way of example only, and are not intended to limit the scope of the invention. For example, many of the materials and structures described herein may be substituted with other materials and structures without deviating from the spirit of the invention. The present invention as claimed may therefore includes variations from the particular examples and preferred aspects described herein, as will be apparent to one of skill in the art. It is understood that various theories as to why the invention works are not intended to be limiting.

What is claimed is:

1. An emissive complex having the formula: 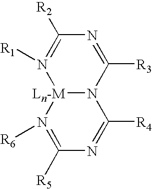
wherein M is a transition metal or a lanthanide;
wherein n is 0, 1, 2, 3, 4, 5, or 6;
wherein there are n independently selected ligands L;
wherein L is a monodentate, bidentate, or tridentate ligand;
wherein each of R₁, R₂, R₃, R₄, R₅, and R₆ is independently selected from the group consisting of hydrogen, alkyl, aryl, and heteroaryl;
wherein one or more of R₁, R₂, R₃, R₄, R₅, and R₆ may be linked; and
wherein at least one of the pairs R₁ and R₂, R₃ and R₄, R₅ and R₆ is linked to form a cyclic group.

2. The complex of claim 1, wherein each of the pairs R₁ and R₂, R₃ and R₄, and R₅ and R₆ are linked to form a cyclic group.

3. The complex of claim 1, wherein M is Pt.

4. The complex of claim 1, wherein at least 1 additional aryl or heteroaryl is fused to the pair R₁ and R₂, R₃ and R₄, and R₅ and R₆ that is linked to form a cyclic group.

5. The complex of claim 1, wherein the complex has the formula: 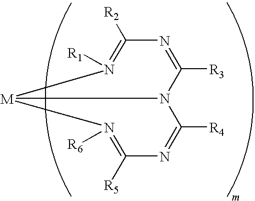
wherein m is 1, 2, or 3.

6. The complex of claim 1, wherein the pair R₃ and R₄ is linked to form a cyclic group.

7. The complex of claim 6, wherein the pair R₃ and R₄ is a hydrocarbon group.

8. The complex of claim 7, wherein the pair R₃ and R₄, illustrated as attached to the nitrogen and carbon atoms of the complex, is selected from the group consisting of:

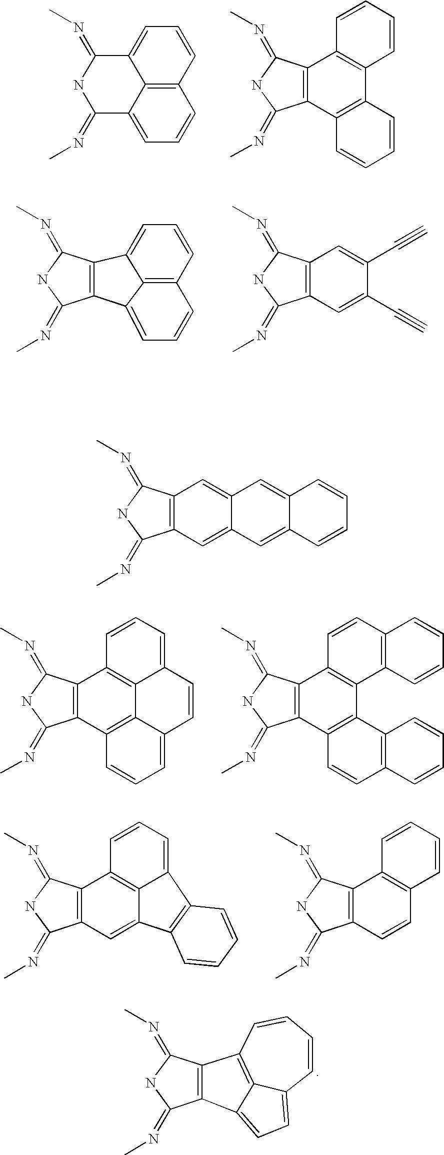

9. The complex of claim 1, wherein the pair R₃ and R₄ is linked to form a cyclic group.

10. The complex of claim 9, wherein the pair R₃ and R₄ is a heteroatomic group.

11. The complex of claim 10, wherein the pair R₃ and R₄, illustrated as attached to the nitrogen and carbon atoms of the complex, is selected from the group consisting of: 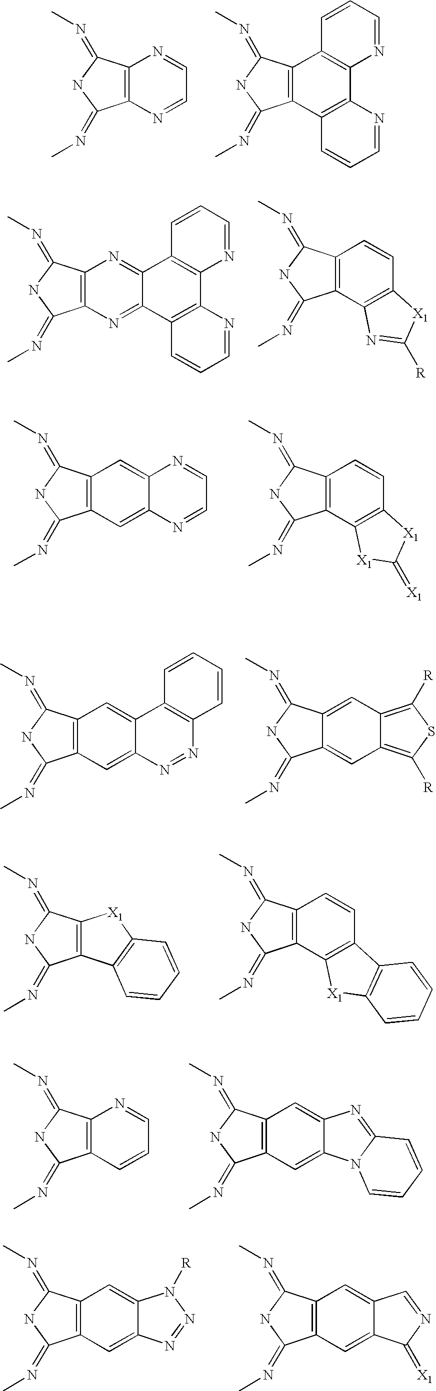 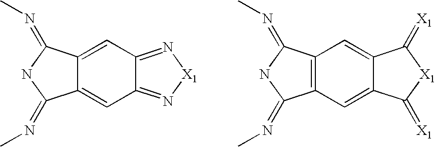
wherein X₁ is selected from the group consisting of S, O, and NR, where R is any alkyl group or hydrogen.

12. The complex of claim 1, wherein the pair R₁ and R₂ is linked to form a cyclic group.

13. The complex of claim 12, wherein the pair R₁ and R₂ is a heteroatomic group.

14. The complex of claim 13, wherein the pair R₁ and R₂, illustrated as attached to the nitrogen and carbon atoms of the complex, is selected from the group consisting of:

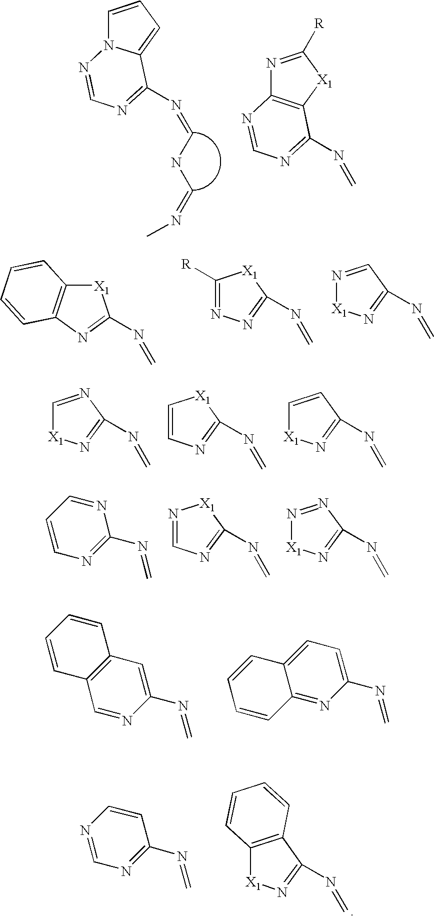

15. The complex of claim 1, wherein each of the pairs R₁ and R₂, and R₅ and R₆ are linked to form a cyclic group.

16. The complex of claim 15, wherein each of the pairs R₁ and R₂, and R₅ and R₆ are a heteroatomic group.

17. The complex of claim 16, wherein each of the pairs R₁ and R₂, and R₅ and R₆, illustrated as attached to the nitrogen and carbon atoms of the complex, are selected from the group consisting of:

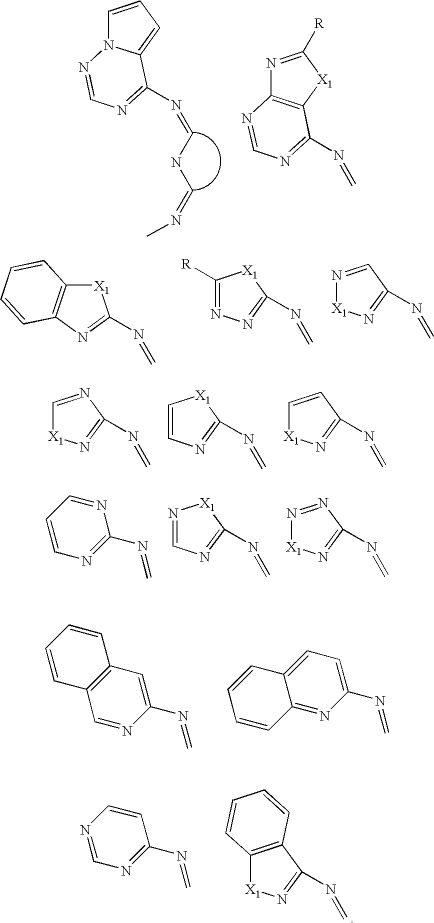

18. The complex of claim 16, wherein each of the pairs R₁ and R₂, and R₅ and R₆, illustrated as attached to the nitrogen and carbon atoms of the complex, are independently selected from the group consisting of:

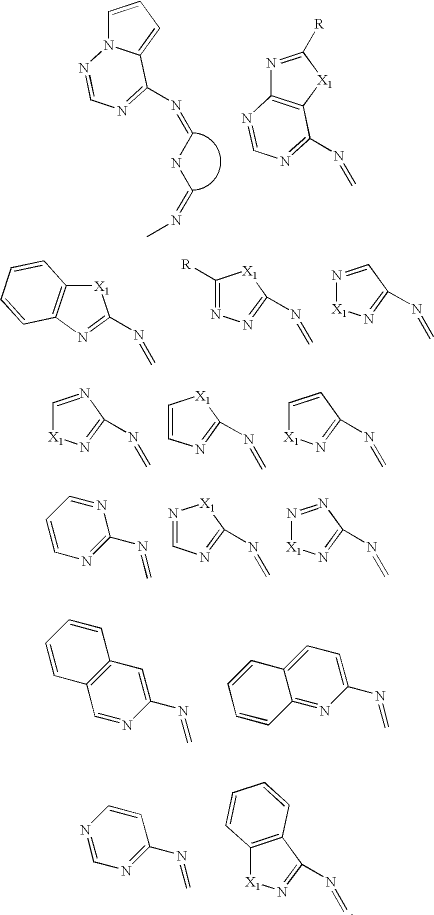

19. The complex of claim 6, wherein multiple metals are coordinated.

20. The complex of claim 19, wherein the pair R₃ and R₄, illustrated as attached to the nitrogen and carbon atoms of the complex, is selected from the group consisting of:

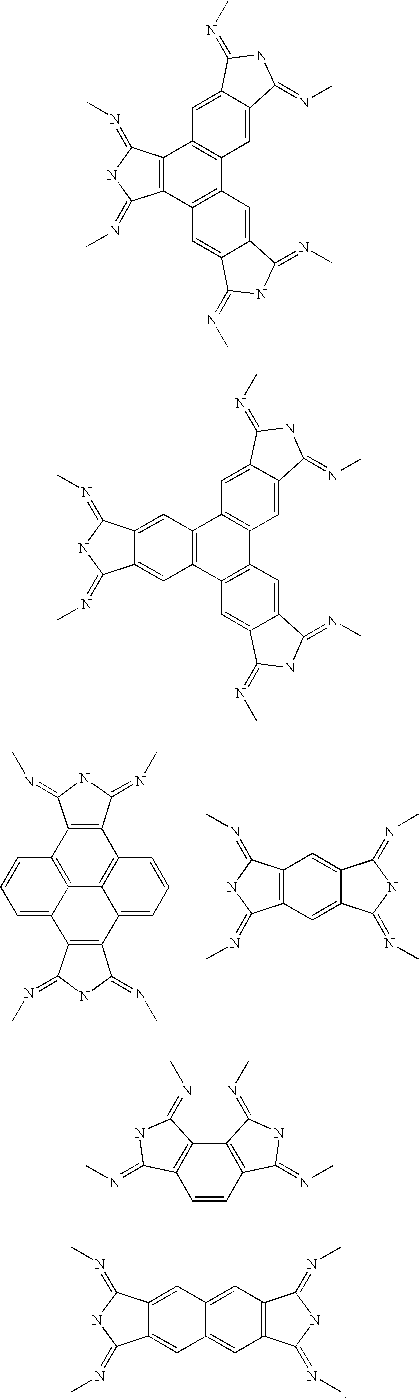

21. An organic light emitting device comprising:
an anode;
a cathode; and
an organic emissive layer, disposed between the anode and the cathode, the organic layer further comprising a complex having the formula: 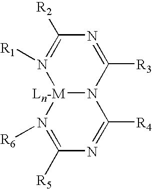
wherein M is a transition metal or a lanthanide;
wherein n is 0, 1, 2, 3, 4, 5, or 6;
wherein there are n independently selected ligands L;
wherein L is a monodentate, bidentate, or tridentate ligand;
wherein each of R₁, R₂, R₃, R₄, R₅, and R₆ is independently selected from the group consisting of hydrogen, alkyl, aryl, and heteroaryl;
wherein one or more of R₁, R₂, R₃, R₄, R₅, and R₆ may be linked; and
wherein at least one of the pairs R₁ and R₂, R₃ and R₄, R₅ and R₆ is linked to form a cyclic group.

22. The device of claim 21, wherein the complex has each of the pairs R₁ and R₂, R₃ and R₄, R₅ and R₆ linked to form a cyclic group.

23. The device of claim 21, wherein the organic layer is an emissive layer comprising a host and an emissive dopant, and the complex is the emissive dopant.
